(19) United States
(12) Patent Application Publication
(10) Pub. No.: US 2010/0087989 A1
(43) Pub. Date: Apr. 8, 2010

(54) ELECTRIC POWER STEERING DEVICE

(75) Inventors: HIROSHI YAMANAKA, UTSUNOMIYA-SHI (JP); MASATO YUDA, UTSUNOMIYA-SHI (JP); SHIGENORI TAKIMOTO, UTSUNOMIYA-SHI (JP); NORIO YAMAZAKI, UTSUNOMIYA-SHI (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., TOKYO (JP)

(21) Appl. No.: 12/566,310

(22) Filed: Sep. 24, 2009

(30) Foreign Application Priority Data
Oct. 3, 2008 (JP) JP2008-258602

(51) Int. Cl. G06F 19/00; B62D 6/00

(52) U.S. Cl. 701/41

(57) ABSTRACT

An electric power steering device for a vehicle includes: a steering wheel return control unit that performs a steering wheel return control when a direction of a steering angle and a direction of a steering angular velocity is different; and a μ-split control unit that performs a μ-split control in order to suppress a behavior of the vehicle traveling on a μ-split road; wherein when the μ-split control unit performs the μ-split control, a value of a steering wheel return control gain in the steering wheel return control unit is set to be lower than a value which is used when the μ-split control is not performed.

### BACKGROUND OF THE INVENTION

1. Field of the Invention

The present invention relates to an electric power steering device capable of performing a steering wheel return control and a μ-split control.

Priority is claimed on Japanese Patent Application No. 2008-258602, filed Oct. 3, 2008, the contents of which are incorporated herein by reference.

2. Description of the Related Art

An electric power steering device for a vehicle is a device to reduce a steering force required to be applied by a driver to control a steering wheel. Some types of electric power steering devices are capable of performing a “steering wheel return control” and/or a “μ-split control”.

The “steering wheel return control” is a function performed to correct a target current (that is, target value for assisting a steering wheel) for a steering assist motor (hereinafter referred to as “assist motor”) so as to compensate for a surplus or a shortage of self-alignment torque received from a reaction force applied from a road surface, thereby correcting the direction of the steering wheel in a direction so that the steering wheel returns to the neutral position. (For example, see Japanese Patent Publication No. 3847179).

When a vehicle travels on a road with one side of the road (for example, the right side) having a higher frictional surface and the other road side (for example, the left side) having a lower frictional surface (hereinafter, referred to as “μ-split road”), that is, when the left wheels and the right wheels of the vehicle run on the left and right sides of a road having different frictional coefficients, the vehicle can easily deviate in a direction toward the road side having a higher frictional surface. This vehicle behavior occurs frequently especially at the time of a braking operation.

The “μ-split control” is a function performed to suppress the above-mentioned irregular vehicle behavior caused by the μ-split road. Performing the “μ-split control” when the vehicle travels on a μ-split road and is deviating in a direction toward the side having a higher frictional surface, means that a target current for the assist motor will be corrected. Then, the steering wheel is rotated in the direction toward the road side having a lower frictional surface. (For example, see Japanese Unexamined Patent Application, First Publication No. 2005-349914).

Meanwhile, in the electric power steering device capable of performing both of the “steering wheel return control” and the “μ-split control”, the “steering wheel return control” and the “μ-split control” may interfere each other and thereby reduce stability of the vehicle.

The present invention is made in view of the aforementioned circumstances, and an object thereof is to provide an electric power steering device for a vehicle that can improve stabilization of the vehicle travelling on a μ-split road.

### SUMMARY OF THE INVENTION

In order to solve the above-described problems and achieve the object, the present invention employs the following.

(1) An aspect of the invention is an electric power steering device for a vehicle including: a steering wheel return control unit that performs a steering wheel return control when the direction of a steering angle and the direction of the steering angular velocity are different, by applying an assist force to the steering wheel in a direction so that the steering wheel returns to a neutral position via an steering assist motor; and a μ-split control unit that performs a μ-split control in order to suppress a behavior of the vehicle traveling on a μ-split road on which surfaces of left-side of the μ-split road and right-side of the μ-split road have different frictional coefficients, by applying an assist force to the steering wheel in a direction so that the steering wheel moves toward the side of the μ-split road having a lower frictional coefficient, via the steering assist motor, wherein: when the μ-split control unit performs the μ-split control, the value of a steering wheel return control gain in the steering wheel return control unit is set to be lower than the value which is used when the μ-split control is not performed.

With the above constitution, an assist force applied for assisting the steering wheel to return to the direction toward the neutral position (hereinafter, referred to as an assist force for returning the steering wheel), which is generated by a steering wheel return control unit can be minimized when the “μ-split control” is performed.

Therefore, if the “steering wheel return control” and the “μ-split control” interfere each other, an undesirable effect derived from the assist force for returning the steering wheel can be reduced. Then, since the “μ-split control” can be preferentially performed, the stabilization of the vehicle travelling on the μ-split road will be improved

(2) The electric power steering device for a vehicle according to (1) may further include an EPS basic control unit that calculates an assist value according to a steering torque. In addition, a signal output from the steering wheel return control unit and a signal output from the μ-split control unit are added to a signal output from the EPS basic control unit.

(3) The electronic power steering device according to (1) may include a μ-split road determination unit that determines whether the road on which the vehicle travels is a μ-split road or not.

(4) In the electric power steering device according to (3), the μ-split road determination unit may determine whether the road is the μ-split road or not, based on at least one of the difference between wheel speeds of left and right front wheels and the difference between wheel speeds of left and right rear wheels.

(5) In the electric power steering device according to (3), the μ-split road determination unit may determine whether the road is a μ-split road or not, based on at least one of the difference between caliper pressures of left and right front wheels and the difference between caliper pressures of left and right rear wheels.

(6) In the electric power steering device according to (3), the μ-split road determination unit may determine whether the road is a μ-split road or not, based on at least one of the difference between torques applied to left and right front wheels and the difference between torques applied to left and right rear wheels.

(7) In the electric power steering device according to (3), the μ-split road determination unit may determine whether the road is a μ-split road or not, based on at least one of the difference between slip ratios of left and right front wheels and the difference between slip ratios of left and right rear wheels.

(8) The electric power steering device according to (1) may further include a steering wheel return determination unit that determines whether or not the driver moves the steering wheel in a direction so that the steering wheel returns to the neutral position, based on the direction of the steering angle and the direction of the steering angular velocity.

### BRIEF DESCRIPTION OF THE DRAWINGS

FIG. 1 is a schematic configuration illustrating an electric power steering device according to an embodiment of the present invention.

FIG. 2 is a flowchart illustrating processes for calculating control gain according to the embodiment.

FIG. 3 is a flowchart illustrating processes for controlling the electric power steering device according to the embodiment.

FIG. 4 illustrates a “μ-split control” performed in the electric power steering device according to the embodiment.

### DETAILED DESCRIPTION OF THE INVENTION

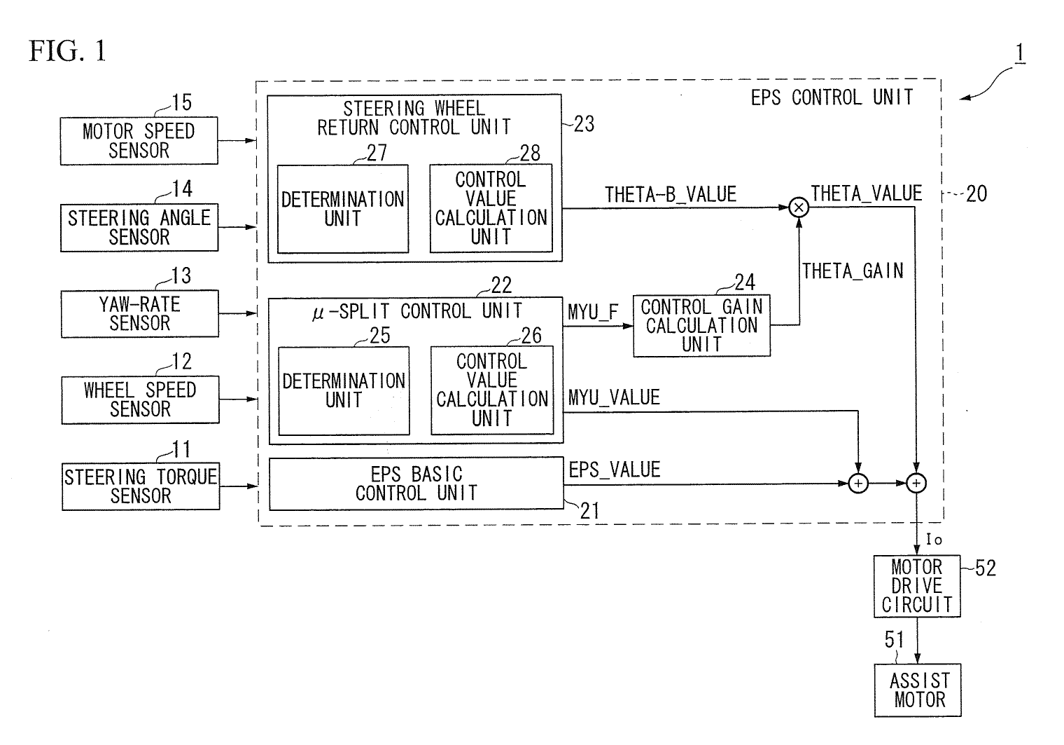

Hereinafter, an embodiment of an electric power steering device according to the present invention will be described in detail with reference to FIG. 1 to FIG. 3.

As shown in FIG. 1, an electric power steering device 1 used for a vehicle includes a steering assist motor 51 (hereinafter, referred to as “assist motor 51”) which generates a steering assist torque, a motor drive circuit 52 which drives the assist motor 51, and an electric power steering control unit 20 (hereinafter, referred to as “EPS control unit 20”).

The EPS control unit 20 receives output signals from a steering torque sensor 11, a wheel speed sensor 12, a yaw-rate sensor 13, a steering angle sensor 14, and a motor speed sensor 15, according to values detected by these sensors. Specifically, the steering torque sensor 11 detects the steering torque applied to a steering shaft (not shown). The wheel speed sensors 12 respectively detect the speed of each wheel. The yaw-rate sensor 13 detects the yaw-rate generated in the vehicle. The steering angle sensor 14 detects the steering angle of the steering wheel (not shown). The motor speed sensor 15 detects the rotational speed (motor speed) of the assist motor 51.

The electric power steering device 1 assists a steering force applied by a driver, by applying the assist torque generated in the assist motor 51 to a pinion shaft (not shown) in a steering mechanism.

The EPS control unit 20 includes an EPS basic control unit 21, a μ-split control unit 22, a steering wheel return control unit 23, and a control gain calculation unit 24.

The EPS basic control unit 21 calculates an EPS basic control value “EPS_VALUE” for the assist motor 51, based on the steering torque detected by the steering torque sensor 11, the velocity of the vehicle (vehicle speed) which is calculated from the wheel speed of each wheel detected by the wheel speed sensors 12, and the motor speed of the assist motor 51 detected by the motor speed sensor 15.

Since the present invention employs a method for calculating the EPS basic control value “EPS_VALUE” which is used in publically-known electric power steering devices, the calculation method will be concisely explained as follows. In short, the EPS basic control value “EPS_VALUE” is increased upon an increase of the steering torque, decreased upon an increase of the vehicle speed, and decreased upon an increase of the rotational speed of the assist motor 51 (in other words, decreased according to the increase of the steering angular velocity).

The μ-split control unit 22 includes a μ-split road determination unit 25 (abbreviated as “DETERMINATION UNIT” in FIG. 1) and a μ-split control value calculation unit 26 (abbreviated as “CONTROL VALUE CALCULATION UNIT” in FIG. 1).

The μ-split road determination unit 25 determines whether a road surface on which the vehicle is travelling is a μ-split road or not. Within several μ-split road determination methods, this embodiment employs the following μ-split road determination method. That is, it is determined whether the road is a μ-split road or not, based on the wheel speed difference(s) which is/are the difference between the front right wheel speed and the front left wheel speed which are detected by the respective wheel speed sensors 12 and/or the difference between a rear right wheel speed and a rear left wheel speed which are detected by the respective wheel speed sensors 12. More specifically, if the wheel speed difference(s) is/are higher than the predetermined value, the μ-split determination unit 25 determines that the road is a μ-split road. On the other hand, if the wheel speed difference(s) is/are lower than the predetermined value, the μ-split determination unit 25 determines that the road is not a μ-split road.

If the μ-split road determination unit 25 determines that the road is a μ-split road, a μ-split control flag “MYU_F=1” is sent to the control gain calculation unit 24. However, if the μ-split road determination unit 25 determines that the road is not a μ-split road, a μ-split control flag “MYU_F=0” is sent to the control gain calculation unit 24.

In another μ-split road determination method, it is determined whether the road is a μ-split road or not, based on the caliper pressure difference(s) which is/are the difference between the caliper pressure of the front right wheel and the caliper pressure of the front left wheel, and/or the difference between the caliper pressure of the rear right wheel and the caliper pressure of the rear left wheel. Further, in another μ-split road determination method, it is determined whether the road is a μ-split road or not, based on the torque difference(s) which is/are the difference between the torque applied to the front right wheel and the torque applied to the front left wheel, and/or the difference between the torque applied to the rear right wheel and the torque applied to the rear left wheel. Furthermore, in another μ-split road determination method, it is determined whether the road is a μ-split road or not, based on the slip ratio difference(s) which is/are the difference between the slip ratio of the front right wheel and the slip ratio of the front left wheel, and/or the difference between the slip ratio of the rear right wheel and the slip ratio of the rear left wheel.

If the μ-split road determination unit 25 determines that the road is a μ-split road, the μ-split control value calculation unit 26 calculates a control value for correcting the target current for the assist motor 51, in order to suppress irregular vehicle behavior caused by the μ-split road.

More specifically, if the vehicle travels on the μ-split road, the vehicle is easily to be moved in a direction toward the side of the road having a higher frictional surface, especially at the time of a braking operation. This behavior of the vehicle is represented by a yaw-rate. Therefore, if the yaw-rate is generated in the vehicle travelling on the μ-split road, the μ-split control value calculation unit 26 calculates a control value (hereinafter, referred to as “μ-split control value”) “MYU_VALUE” for correcting the EPS basic control value “EPS_VALUE”, so as to move the steering wheel in a direction so that the yaw-rate can be suppressed, that is, a direction toward the side of the road having a lower frictional surface where the steering wheel should be moved.

The μ-split control value “MYU_VALUE” is calculated based on the wheel speed difference, the caliper pressure difference, the torque difference, or the slip ratio difference, which is used in the above-mentioned μ-split road determination. The μ-split control value “MYU_VALUE” is increased upon an increase of the difference. The EPS basic control value “EPS_VALUE” is corrected according to the vehicle speed, specifically, the μ-split control value “MYU_VALUE” is increased upon an increase of the vehicle speed.

The steering wheel return control unit 23 includes a steering wheel return determination unit 27 (abbreviated as “determination unit” in FIG. 1) and a steering wheel return control value calculation unit 28 (abbreviated as “control value calculation unit” in FIG. 1).

The steering wheel return determination unit 27 determines whether or not the driver moves the steering wheel in a direction so that the steering wheel returns to the neutral position, based on a signal output from the steering angle sensor 14 and a signal output from the motor speed sensor 15.

More specifically, if the direction of the steering angle calculated based on the signal output from the steering angle sensor 14 (i.e., whether the steering wheel is rotated in the clockwise direction or in the counterclockwise direction, with respect to the neutral position) and the direction of the steering velocity (steering angular velocity) calculated based on the signal output from the motor speed sensor 15 (i.e., whether the steering wheel is being moved in the clockwise direction or in the counterclockwise direction) are different directions, the steering wheel return determination unit 27 determines that the driver is moving the steering wheel in a direction so that the steering wheel returns to the neutral position. That is, it is determined that the steering wheel is being returned by the driver. On the other hand, if the direction of the steering angle and the direction of the steering velocity (angle velocity) are the same direction, the steering wheel return determination unit 27 determines that the driver is moving the steering wheel in the direction so that the steering wheel is moved away from the neutral position. That is, it is determined that the steering wheel is being moved away by the driver.

If the steering wheel return determination unit 27 determines that the steering wheel is being returned by the driver, the steering wheel return control value calculation unit 28 calculates the control value (hereinafter, referred to as “steering wheel return basic control value”) “THETA-B_VALUE” for correcting the EPS basic control value “EPS_VALUE”, so as to correct the steering wheel in a direction so that the steering wheel returns to the neutral position.

The steering wheel return basic control value “THETA-B_VALUE” is calculated based on, for example, the steering angle detected by the steering angle sensor 14 and the motor speed (steering angular velocity) of the assist motor 51 detected by the motor speed sensor 15, with reference to a map or the like. In this map, in short, the steering wheel return basic control value “THETA-B_VALUE” is increased upon an increase of the steering angle, and is decreased upon an increase of the motor speed (steering angular velocity).

The control gain calculation unit 24 calculates the steering wheel return control gain “THETA_GAIN” based on a μ-split control flag “MYU_F” inputted in the μ-split control unit 22.

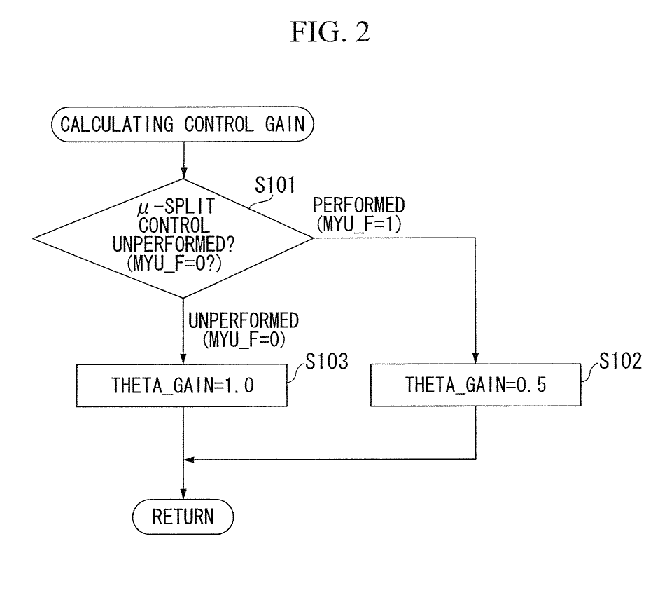

With reference to the flowchart in FIG. 2, control gain calculation processes performed in the control gain calculation unit 24 will be explained as below. It should be noted that the control gain calculation processes shown in the flowchart in FIG. 2 repeats periodically.

Firstly, in Step S101, it is determined whether a “μ-split control” is “UNPERFORMED” or not, based on a μ-split control flag “MYU_F” inputted in the μ-split control unit 22. More specifically, if a μ-split control flag “MYU_F=0” is inputted, the μ-split control value calculation unit 26 does not calculate a μ-split control value “MYU_VALUE”, that is, the μ-split control unit 22 does not substantially perform “μ-split control”. Therefore, a result of the μ-split control determination is “UNPERFORMED” in Step S101. Meanwhile if a μ-split control flag “MYU_F=1” is inputted, the μ-split control value calculation unit 26 calculates a μ-split control value “MYU_VALUE”, that is, the μ-split control unit 22 performs “μ-split control”. Therefore, a result of the μ-split control determination is “PERFORMED” in Step S101.

If the μ-split control determination result is “PERFORMED” in Step S101, a value of the steering wheel return control gain “THETA_GAIN” is set to be lower than the normal value “1.0” in S102. For example, the value may be set to “0.5”, and the steering wheel return is performed.

If the μ-split control determination result is “UNPERFORMED” in S101, a value of the steering wheel return control gain “THETA_GAIN” is set to be the normal value “1.0” in S103, and the steering wheel return is performed.

The EPS control unit 20 obtains the steering wheel return control value “THETA_VALUE” by multiplying the steering wheel return basic control value “THETA-B_VALUE” which is calculated by the steering wheel return control value calculation unit 28, by the steering wheel return control gain “THETA_GAIN” which is calculated by the control gain calculation unit 24.

The EPS control unit 20 obtains a target current Io for the assist motor 51 by adding the EPS basic control value “EPS_VALUE” which is calculated in the EPS basic control unit 21, the μ-split control value “MYU_VALUE” calculated in the μ-split control unit 22, and the steering wheel return control value “THETA_VALUE”. Then, the EPS control unit 20 transmits the obtained target current Io to the motor drive circuit 52.

That is, both of the μ-split control value “MYU_VALUE” and the steering wheel return control value “THETA_VALUE” can be considered as values for correcting the EPS basic control value “EPS_VALUE” for the assist motor 51. Then, the μ-split control value “MYU_VALUE” can be recognized as a component for generating an assist force to move the steering wheel in the direction toward the road side having a lower frictional surface via the assist motor 51, and the steering wheel return control value “THETA_VALUE” can be recognized as a component for generating an assist force to return the steering wheel in the direction toward the neutral position via the assist motor 51.

In the motor drive circuit 52, a feed back control is performed so that an actual current in the assist motor 51 coincides with the target current Io.

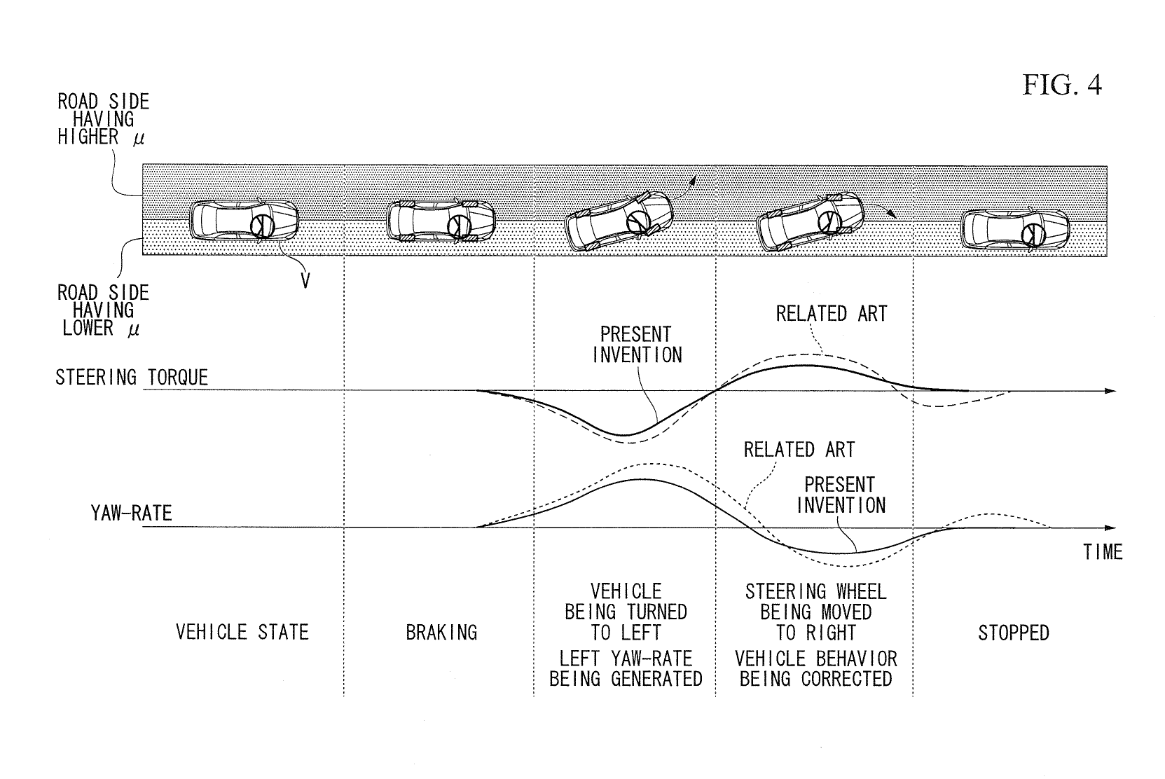

With reference to FIG. 4 as an example, effects achievable from the above-mentioned configuration of the electric power steering device 1 will be explained as follows.

Assuming a situation that a vehicle V, which has been travelling straight on a μ-split road on which the right side of the road has a lower frictional surface and the left side of the road has a higher frictional surface, is subject to a braking operation (in a state of “BRAKING” in FIG. 4). That is, the left wheels of the vehicle V run on the left side of the road having a higher frictional surface and the right wheels of the vehicle V run on the right side of the road having a higher frictional surface. It should be noted that the below explanation is merely a model case, and the present invention should not be limited to this model case.

In this situation, different frictional coefficients between the left and right sides of the road cause different braking forces between the left and right sides of the vehicle V, thereby generating a yaw-moment turning the vehicle V in a direction toward the road having a higher frictional surface (In this situation, the yaw-moment is directed to the left rotational direction). Then, the vehicle V turns to the left direction, and a left directional yaw-rate is generated in the vehicle V (in a state of “VEHICLE BEING TURNED TO LEFT” in FIG. 4). Here, in the μ-split control unit 22 of the EPS control unit 20, the μ-split road determination unit 25 determines that the road is a μ-split road. Then, the μ-split control value calculation unit 26 calculates the μ-split basic control value “MYU-B_VALUE”, thereby performing the “μ-split control”. That is, before the driver moves the steering wheel, the steering assist is performed by the assist motor 51 so as to move the steering wheel in a direction toward the road side having lower frictional surface.

Meanwhile, at the same time or after the “μ-split control” is performed by the μ-split control unit 22, the driver moves the steering wheel to the right rotational direction so as to recover the direction of the vehicle V to the straight direction (in a state of “STEERING WHEEL BEING CONTROLLED TO RIGHT” in FIG. 4). Here, in the EPS control unit 20, though the EPS basic control unit 21 and the μ-split control unit 22 work, the steering wheel return control unit 23 does not work since the steering wheel is being moved away from the neutral position.

Recovering the vehicle behavior, the driver lessens the right directional steering torque controlling the steering wheel to the right direction, in order to return the steering wheel to the neutral position. Since the steering wheel is being returned to the neutral position, the EPS basic control unit 21, the μ-split control unit 22, and the steering wheel return control unit 23 simultaneously work in the EPS control unit 20.

Here, this “steering wheel return control” is performed in a state that the steering wheel is controlled to the right direction. Therefore, steering wheel return control value “THETA_VALUE” works as a component for assisting the steering wheel to rotate in the left direction, and corrects the EPS basic control value “EPS_VALUE” for the assist motor 51. The direction of the vector of this component is opposite to the direction of the vector suppressing the irregular behavior of the vehicle V caused by the μ-split road. That is, the steering wheel return control unit might reduce the effect of the “μ-split control”.

In the electric power steering device 1 of this embodiment, when the “μ-split control” is performed, the value of the steering wheel return control gain “THETA_GAIN” to be lower than a value which is used when the “μ-split control” is not performed (for example, “THETA_GAIN=0.5” is set). Therefore, a component for assisting the steering wheel to rotate in the left direction (assist force for returning the steering wheel) may be minimized. With this configuration, a “μ-split control” can be preferentially performed at the time of performing “μ-split control”, and the undesirable effect of the “steering wheel return control” can be reduced. Then, the irregular vehicle behavior can be settled quickly and thus, stabilization of the vehicle behavior at the time of travelling on the μ-split road can be improved.

It should be noted that, in the above explanation, the situation where the braking operation is performed is merely used as an example, and the instant invention can be used in a situation where the braking operation is not performed.

Two graphs in FIG. 4 show the steering torque and yaw-rate, when the “steering wheel return control” works to the opposite directional vector to the direction of the “μ-split control”. The continuous lines represents a case where the value of the steering wheel return control gain “THETA_GAIN” is set to be lower than the value used when the μ-split control is not performed, as explained in the above embodiment of the present invention. Meanwhile, interrupted lines (related art) represent a case that a value of the steering wheel return control gain “THETA_GAIN” is set to be the value used when the μ-split control is not performed.

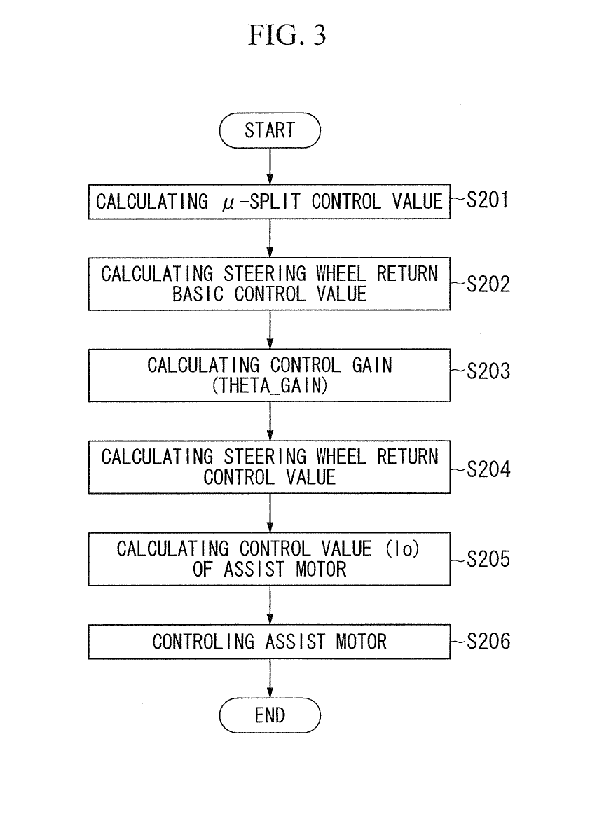

With reference to the flowchart in FIG. 3, processes for controlling the assist motor 51 of the electric power steering device 1 will be explained below.

In Step S201, if a road is determined as a μ-split road, the μ-split control value “MYU_VALUE” is calculated.

In Step S202, a steering wheel return basic control value “THETA-B_VALUE” is calculated.

In Step S203, a steering wheel return control gain “THETA_GAIN” is calculated.

In Step S204, a steering wheel return control value “THETA_VALUE” is calculated by multiplying the steering wheel return basic control value “THETA-B_VALUE” by the steering wheel return control gain “THETA_GAIN”.

In Step S205, a control value (target current I₀) for the assist motor 51 is calculated, by adding EPS basic control value “EPS_VALUE”, the μ-split control value “MYU_VALUE”, and the steering wheel return control value “THETA_VALUE”.

In Step S206, the assist motor 51 is controlled.

While the preferred embodiment of the invention has been described and illustrated above, it should be understood that it is exemplary of the invention and is not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

For example, in the above explained embodiment, the value of the steering wheel return control gain “THETA_GAIN” at the time of performing “μ-split control” should not be limited to “0.5”, and the present invention may employ another value. For example, any value lower than 1.0, or even “THETA_GAIN=0” may be employed.

What is claimed is:

1. An electric power steering device for a vehicle comprising:
a steering wheel return control unit that performs a steering wheel return control when a direction of a steering angle and a direction of a steering angular velocity is different, by applying an assist force to the steering wheel in a direction so that the steering wheel returns to a neutral position via an steering assist motor; and
a μ-split control unit that performs a μ-split control in order to suppress behavior of the vehicle traveling on a μ-split road on which surfaces of a left side of a road and a right side of a road have different frictional coefficients, by applying an assist force to the steering wheel in a direction that the steering wheel moves toward the left or right side of a road having a lower frictional coefficient, via the steering assist motor, wherein:
when the μ-split control unit performs the μ-split control, a value of a steering wheel return control gain in the steering wheel return control unit is set to be lower than a value which is used when the μ-split control is not performed.

2. The electric power steering device according to the claim 1, further comprising an EPS basic control unit that calculates an assist value according to a steering torque, wherein:
a signal output from the steering wheel return control unit and a signal output from the μ-split control unit are added to a signal output from the EPS basic control unit.

3. The electronic power steering device according to the claim 1, further comprising a μ-split road determination unit that determines whether the road on which the vehicle travels is a μ-split road or not.

4. The electric power steering device according to the claim 3, wherein
the μ-split road determination unit determines whether the road is the μ-split road or not, based on at least one of a difference between wheel speeds of left and right front wheels and a difference between wheel speeds of left and right rear wheels.

5. The electric power steering device according to the claim 3, wherein
the μ-split road determination unit determines whether the road is a μ-split road or not, based on at least one of a difference between caliper pressures of left and right front wheels and a difference between caliper pressures of left and right rear wheels.

6. The electric power steering device according to the claim 3, wherein
the μ-split road determination unit determines whether the road is the μ-split road or not, based on at least one of a difference between torques applied to left and right front wheels and a difference between torques applied to left and right rear wheels.

7. The electric power steering device according to the claim 3, wherein
the μ-split road determination unit determines whether the road is a μ-split road or not, based on at least one of a difference between slip ratios of left and right front wheels and a difference between slip ratios of left and right rear wheels.

8. The electric power steering device according to the claim 1, further comprising a steering wheel return determination unit that determines whether or not the driver moves the steering wheel in a direction so that the steering wheel returns to the neutral position, based on a direction of the steering angle and a direction of the steering angular velocity.
